(19) United States
(12) Patent Application Publication
(10) Pub. No.: US 2026/0146966 A1
(43) Pub. Date: May 28, 2026

(54) SENSOR

(71) Applicant: KABUSHIKI KAISHA TOSHIBA, Tokyo (JP)

(72) Inventors: Yosuke AKIMOTO, Yokohama Kanagawa (JP); Shihe WANG, Kawasaki Kanagawa (JP); Hiroshi HAMASAKI, Hiratsuka Kanagawa (JP); Yui YAMAZAKI, Ota Tokyo (JP)

(73) Assignee: KABUSHIKI KAISHA TOSHIBA, Tokyo (JP)

(21) Appl. No.: 19/256,239

(22) Filed: Jul. 1, 2025

(30) Foreign Application Priority Data
Nov. 25, 2024 (JP) 2024-204963

(51) Int. Cl. G01N 27/12

(52) U.S. Cl. CPC G01N 27/122

(57) ABSTRACT

According to one embodiment, a sensor includes a base and a first detection portion. The first detection portion includes a first base electrode fixed to the base, a first fixed portion fixed to the base, and a first element supported by the first fixed portion. The first element includes a first resistance member and a first element electrode. A first gap is provided between the first base electrode and the first element. A first electrical resistance of the first resistance member is configured to change in response to a detection target around the first element.

### CROSS-REFERENCE TO RELATED APPLICATIONS

This application is based upon and claims the benefit of priority from Japanese Patent Application No.2024-204963, filed on Nov. 25, 2024; the entire contents of which are incorporated herein by reference.

### FIELD

Embodiments described herein relate generally to a sensor.

### BACKGROUND

For example, there is a sensor using a MEMS (Micro Electro Mechanical Systems) element, etc. It is desirable to improve the characteristics of the sensor.

### BRIEF DESCRIPTION OF THE DRAWINGS

FIG. 1 is a schematic cross-sectional view illustrating a sensor according to a first embodiment;

FIG. 2 is a schematic plan view illustrating the sensor according to the first embodiment;

FIG. 3 is a schematic plan view illustrating the sensor according to the first embodiment;

FIG. 4 is a schematic plan view illustrating the sensor according to the first embodiment;

FIG. 5 is a schematic plan view illustrating the sensor according to the first embodiment;

FIG. 6 is a schematic cross-sectional view illustrating a part of the sensor according to the first embodiment;

FIG. 7 is a schematic cross-sectional view illustrating a sensor according to the first embodiment;

FIG. 8 is a schematic plan view illustrating the sensor according to the first embodiment;

FIG. 9 is a schematic cross-sectional view illustrating a sensor according to the first embodiment;

FIG. 10 is a schematic plan view illustrating the sensor according to the first embodiment;

FIG. 11 is a block diagram illustrating the sensor according to the first embodiment;

FIG. 12 is a block diagram illustrating a sensor according to the first embodiment; and

FIG. 13 is a block diagram illustrating a sensor according to the first embodiment.

### DETAILED DESCRIPTION

According to one embodiment, a sensor includes a base and a first detection portion. The first detection portion includes a first base electrode fixed to the base, a first fixed portion fixed to the base, and a first element supported by the first fixed portion. The first element includes a first resistance member and a first element electrode. A first gap is provided between the first base electrode and the first element. A first electrical resistance of the first resistance member is configured to change in response to a detection target around the first element.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

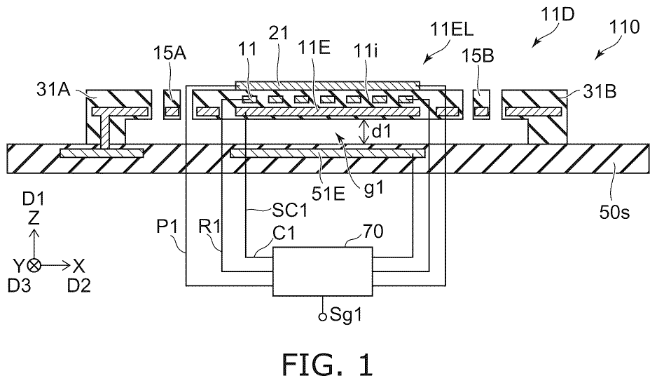

FIG. 1 is a schematic cross-sectional view illustrating a sensor according to a first embodiment.

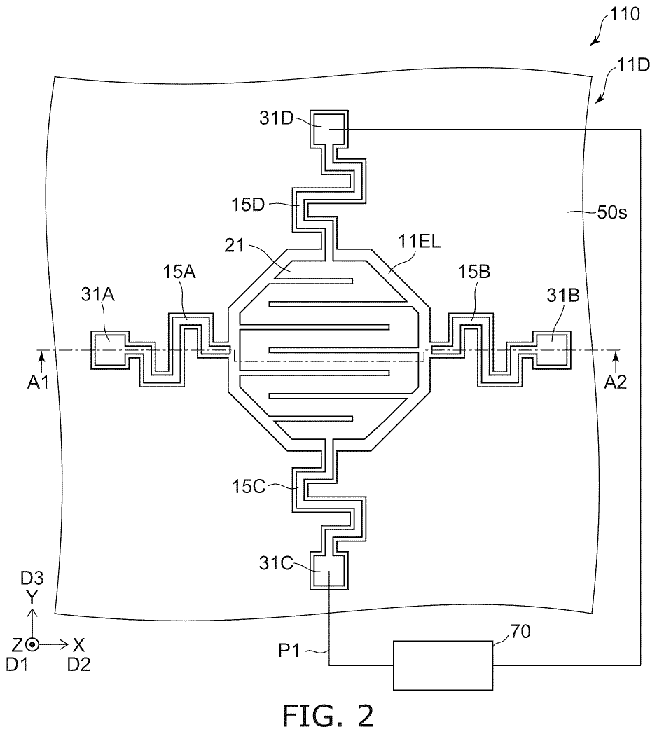

FIGS. 2 to 5 are schematic plan views illustrating the sensor according to the first embodiment.

FIG. 1 is a cross-sectional view taken along the line A1-A2 in FIGS. 2 to 5.

As shown in FIG. 1, a sensor 110 according to the embodiment includes a base 50s and a first detection portion 11D. The first detection portion 11D includes a first base electrode 51E fixed to the base 50s, a first fixed portion 31A fixed to the base 50s, and a first element 11EL supported by the first fixed portion 31A. The first element 11EL includes a first resistance member 11 and a first element electrode 11E. A first gap g1 is provided between the first base electrode 51E and the first element 11EL. A first electrical resistance R1 of the first resistance member 11 is configured to change according to a detection target around the first element 11EL.

For example, the first electrical resistance R1 of the first resistance member 11 changes depending on the state of the detection object. By detecting the first electrical resistance R1, the detection object can be detected.

In this embodiment, the first element electrode 11E is provided to face the first base electrode 51E. In one example, the capacitance between these electrodes is detected. Based on the detected result of the capacitance, a value based on the first electrical resistance R1 obtained from the first resistance member 11 may be corrected. The value based on the first electrical resistance R1 changes depending on the detection target around the first element 11EL. The value based on the first electrical resistance R1 corresponds to the detection result of the detection target.

For example, a distance d1 between the base 50s and the first element 11EL may change due to a change in temperature of the first element 11EL. For example, the distance d1 between the base 50s and the first element 11EL may change due to changes over time. When the distance d1 between the base 50s and the first element 11EL changes, the thermal characteristics (e.g., heat dissipation) of the first element 11EL change. This may cause the first electrical resistance R1 to change unintentionally, separate from the state of the detection target. In such a case, the detection target can be accurately detected by correcting the value based on the first electrical resistance R1 based on the capacitance detection result. A sensor capable of improving characteristics can be provided.

Furthermore, as another example, by controlling at least one of the potential of the first base electrode 51E or the potential of the first element electrode 11E, the distance d1 between the first base electrode 51E and the first element electrode 11E can be controlled. Thereby, it becomes possible to compensate for changes in the distance d1 between the first base electrode 51E and the first element electrode 11E caused by, for example, temperature changes or changes over time, and controlled to be a desired value. This stabilizes the thermal characteristics (for example, heat dissipation) of the first element 11EL. According to the embodiment, the detection target can be accurately detected. A sensor capable of improving characteristics can be provided.

As shown in FIG. 1, the sensor 110 may include a controller 70. The controller 70 may be included in the sensor 110. Alternatively, the controller 70 may be provided separately from the sensor 110. The controller 70 is configured to output an output signal Sg1. In one example, the output signal Sg1 is obtained by correcting the value based on the first electrical resistance R1 based on a first capacitance signal SC1 corresponding to the first capacitance C1 between the first base electrode 51E and the first element electrode 11E. An accurate detection result is obtained. The controller 70 may include a processor.

In the embodiment, a coefficient relating to the relationship between the first electrical resistance R1 obtained from the first resistance member 11 and the concentration of the detection target may be corrected based on the detection result of the capacitance. For example, the detection result of the first electrical resistance R1 is converted to the concentration of the detection target (e.g., gas concentration) based on the coefficient. The converted value (concentration) corresponds to the value based on the first electrical resistance R1. In this case also, the detection target can be accurately detected by correcting the coefficient based on the capacitance detection result.

In the embodiment, the controller 70 may be configured to output information corresponding to the distance d1 between the first base electrode 51E and the first element electrode 11E.

As shown in FIG. 1, in this example, the first element electrode 11E is located between the first base electrode 51E and the first resistance member 11. By providing the first element electrode 11E so as to face the first base electrode 51E, the first capacitance C1 is stabilized.

As shown in FIG. 1, the first element 11EL may further include a first conductive member 21. The controller 70 may be configured to supply a first power P1 to the first conductive member 21 and detect the value corresponding to the first electrical resistance R1.

When the first power P1 is supplied to the first conductive member 21, the temperature of the first element 11EL rises. This causes the temperature of the first resistance member 11 to rise. At this time, the heat dissipation properties of the first element 11EL change depending on the state of the detection object around the first element 11EL. As a result, the temperature of the first resistance member 11 depends on the state of the detection object. The detection object can be detected by detecting the first electrical resistance R1, which changes in response to the temperature of the first resistance member 11.

The detection target may be, for example, a gas. The detection target may include, for example, carbon dioxide. The sensor 110 can detect, for example, the concentration of carbon dioxide. The sensor 110 is, for example, a gas sensor.

As shown in FIG. 1, a first direction D1 from the first base electrode 51E to the first resistance member 11 is defined as a Z-axis direction. One direction perpendicular to the Z-axis direction is defined as an X-axis direction. A direction perpendicular to the Z-axis direction and the X-axis direction is defined as a Y-axis direction.

As shown in FIG. 1, the first resistance member 11 is located between the first element electrode 11E and the first conductive member 21 in the first direction D1.

As shown in FIG. 1, the first element 11EL may include a first insulating member 11i. In this example, the first insulating member 11i is provided between the first element electrode 11E and the first resistance member 11, and between the first resistance member 11 and the first conductive member 21.

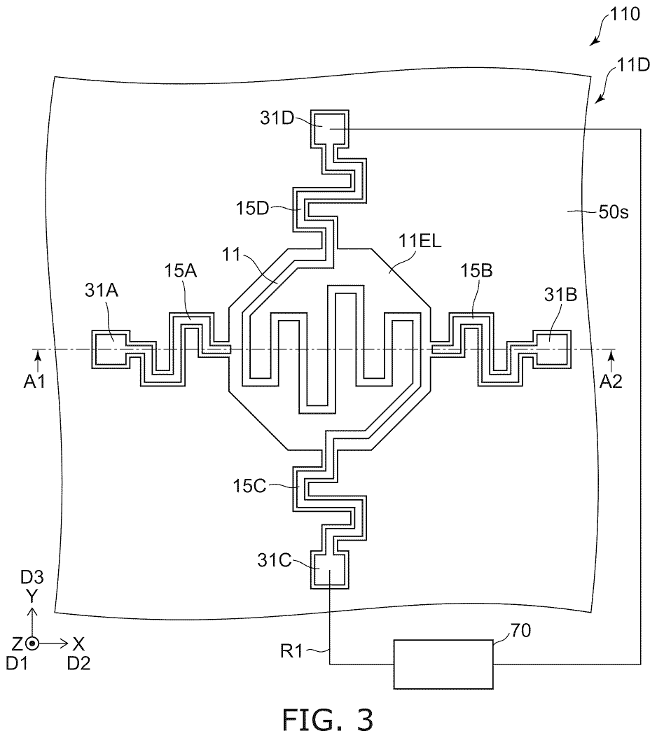

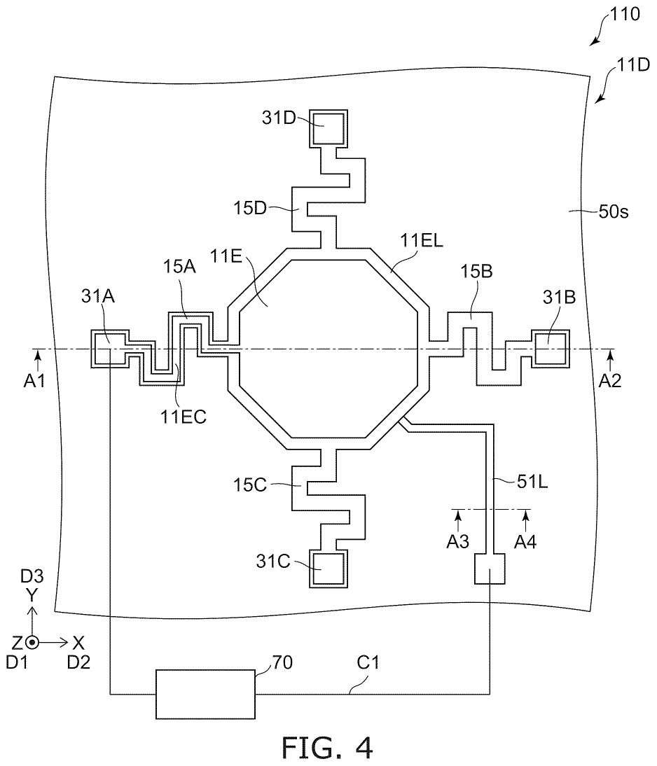

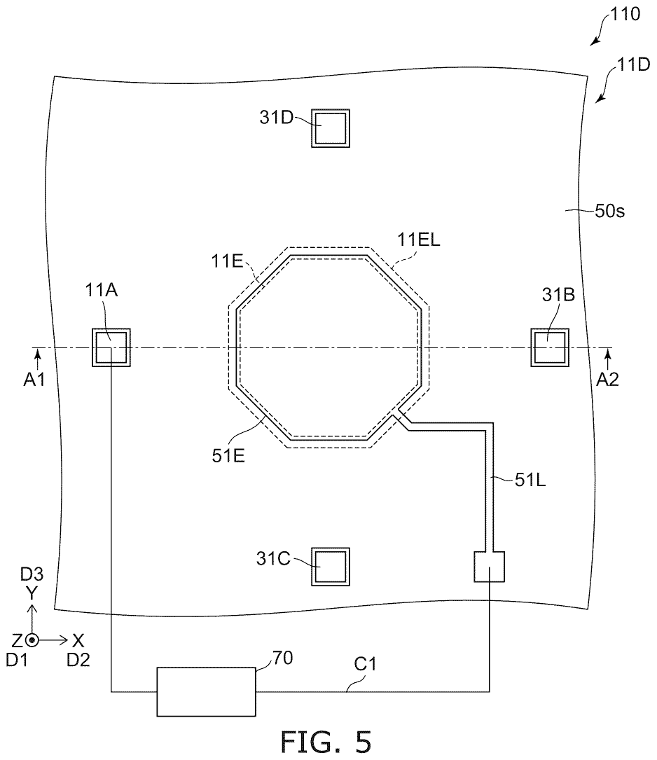

FIG. 2 illustrates an example of a pattern of the first conductive member 21. FIG. 3 illustrates an example of a pattern of the first resistance member 11. FIG. 4 illustrates an example of a pattern of the first element electrode 11E. FIG. 5 illustrates an example of a pattern of the first base electrode 51E. As shown in FIGS. 2 to 5, the first element 11EL may be along the X-Y plane.

As shown in FIG. 1, the first detection portion 11D may further include a first connecting member 15A. The first connecting member 15A is supported by the first fixed portion 31A. The first connecting member 15A supports the first element 11EL. A part of the first gap g1 is provided between the base 50s and the first connecting member 15A.

As shown in FIG. 2, a length of the first connecting member 15A along an extension direction of the first connecting member 15A is longer than a width along a crossing direction crossing the extension direction of the first connecting member 15A. The first connecting member 15A may have, for example, a meandering structure. The first connecting member 15A has, for example, a spring structure. Heat conduction from the first element 11EL is suppressed.

A part of the heat of the first element 11EL is conducted via a connecting member (such as the first connecting member 15A). Another part of the heat of the first element 11EL is conducted to the base 50s via the first gap g1. In the embodiment, for example, a correction is made based on the first capacitance C1. This suppresses the effect of heat conduction to the base 50s via the first gap g1.

As shown in FIGS. 1 and 2, the first detection portion 11D may include a second fixed portion 31B fixed to the base 50s, and a second connecting member 15B supported by the second fixed portion 31B. The second connecting member 15B supports the first element 11EL. A direction from the first connecting member 15A to the second connecting member 15B (e.g., the second direction D2) crosses the first direction D1. The second direction D2 may be, for example, the X-axis direction.

As shown in FIG. 2, the first detection portion 11D may include a third fixed portion 31C, a third connecting member 15C, a fourth fixed portion 31D, and a fourth connecting member 15D. The third fixed portion 31C is fixed to the base 50s. The third connecting member 15C is supported by the third fixed portion 31C. The fourth fixed portion 31D is fixed to the base 50s. The fourth connecting member 15D is supported by the fourth fixed portion 31D. The third connecting member 15C supports the first element 11EL. The fourth connecting member 15D supports the first element 11EL.

A direction from the third connecting member 15C to the fourth connecting member 15D (e.g., the third direction D3) crosses the direction from the first connecting member 15A to the second connecting member 15B. The third direction D3 crosses a plane including the first direction D1 and the second direction D2, for example. By being supported by plurality of such connecting members, the position of the first element 11EL is stabilized.

As shown in FIG. 2, in this example, the conductive member (conductive layer) electrically connected to the first conductive member 21 may be electrically connected to the controller 70 through the third connecting member 15C and the fourth connecting member 15D.

As shown in FIG. 3, in this example, the conductive member (conductive layer) electrically connected to the first resistance member 11 may be electrically connected to the controller 70 through the third connecting member 15C and the fourth connecting member 15D. The position in the Z-axis direction of the conductive member electrically connected to the first conductive member 21 may be different from the position in the Z-axis direction of the conductive member electrically connected to the first resistance member 11.

As shown in FIG. 4, in this example, a first element wiring member 11EC electrically connected to the first element electrode 11E may be electrically connected to the controller 70 through the first connecting member 15A. In this way, the first detection portion 11D may further include the first element wiring member 11EC electrically connected to the first element electrode 11E. The first element wiring member 11EC may pass through the first connecting member 15A.

In the embodiment, the first element wiring member 11EC may pass through any one of the first connecting member 15A, the second connecting member 15B, the third connecting member 15C, and the fourth connecting member 15D. The conductive layer electrically connected to the first resistance member 11 may pass through any one of the first connecting member 15A, the second connecting member 15B, the third connecting member 15C, and the fourth connecting member 15D. The conductive layer electrically connected to the first conductive member 21 may pass through any one of the first connecting member 15A, the second connecting member 15B, the third connecting member 15C, and the fourth connecting member 15D.

As shown in FIG. 5, the first detection portion 11D may further include a first wiring layer 51L electrically connected to the first base electrode 51E. The first base electrode 51E is electrically connected to the controller 70 via the first wiring layer 51L.

As shown in FIG. 4, at least a part of the first wiring layer 51L does not overlap the first connecting member 15A in the first direction D1. At least a part of the first wiring layer 51L does not have to overlap any of the first connecting member 15A, the second connecting member 15B, the third connecting member 15C, and the fourth connecting member 15D in the first direction D1. For example, the effect of the first wiring layer 51L on the characteristics of these plurality of connecting members can be suppressed.

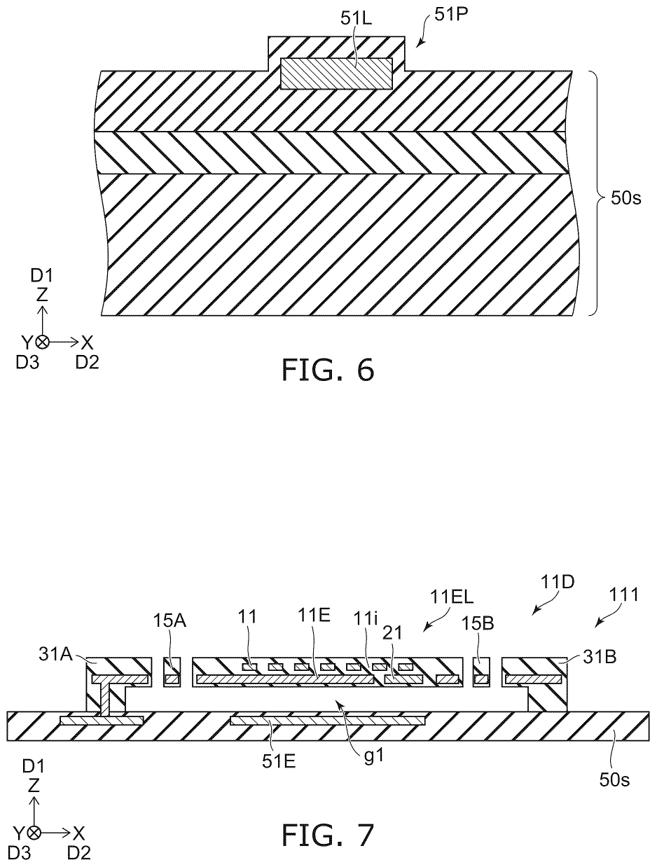

FIG. 6 is a schematic cross-sectional view illustrating a part of the sensor according to the first embodiment.

FIG. 6 is a cross-sectional view taken along the line A3-A4 in FIG. 4. As shown in FIG. 6, the first wiring layer 51L is provided on the base 50s. A protruding portion 51P is formed by the first wiring layer 51L. When such a protruding portion 51P overlaps a part of the plurality of connecting members, the thermal characteristics (heat dissipation, etc.) of the connecting members change partially. As the first wiring layer 51L does not overlap the connecting members, it becomes easier to obtain uniform characteristics.

FIG. 7 is a schematic cross-sectional view illustrating a sensor according to the first embodiment.

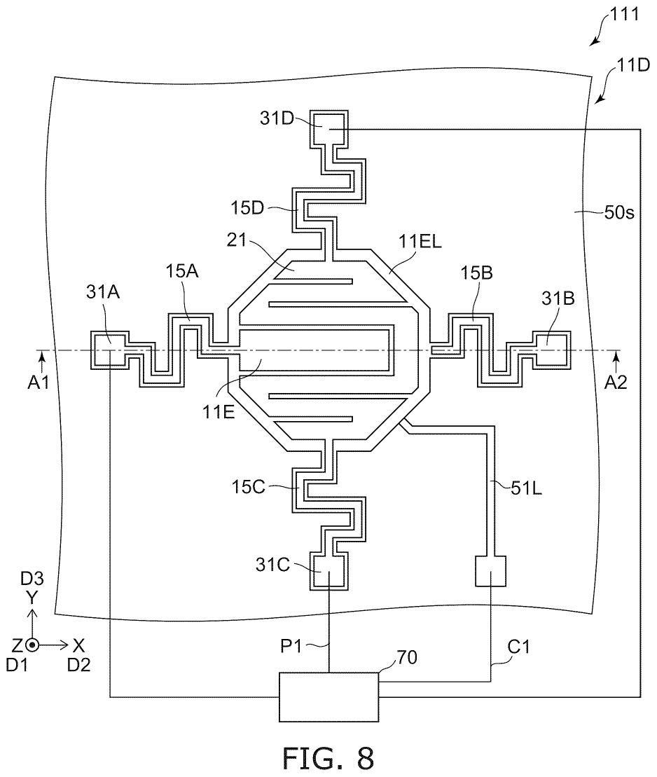

FIG. 8 is a schematic plan view illustrating the sensor according to the first embodiment.

FIG. 7 is a cross-sectional view taken along the line A1-A2 in FIG. 8.

As shown in FIG. 7, in a sensor 111 according to the embodiment, the configuration of the first element electrode 11E and the first conductive member 21 is different from that in the sensor 110. The configuration of the sensor 111 except for this may be the same as the configuration of the sensor 110.

In the sensor 111, the direction from the first element electrode 11E to the first conductive member 21 crosses the first direction D1 from the first base electrode 51E to the first resistance member 11. The direction from the first element electrode 11E to the first conductive member 21 is, for example, the second direction D2. With respect to the base 50s, the height of the first element electrode 11E may be substantially the same as the height of the first conductive member 21.

In this example, the position of the first element electrode 11E in the first direction D1 (first element electrode position) is between the position of the first base electrode 51E in the first direction D1 (first base position) and the position of the first resistance member 11 in the first direction D1 (first resistance member position).

As shown in FIG. 8, in this example, the first conductive member 21 is electrically connected to the controller 70 via a conductive layer that passes through the third connecting member 15C and the fourth connecting member 15D. The first element electrode 11E is electrically connected to the controller 70 via a conductive layer that passes through the first connecting member 15A.

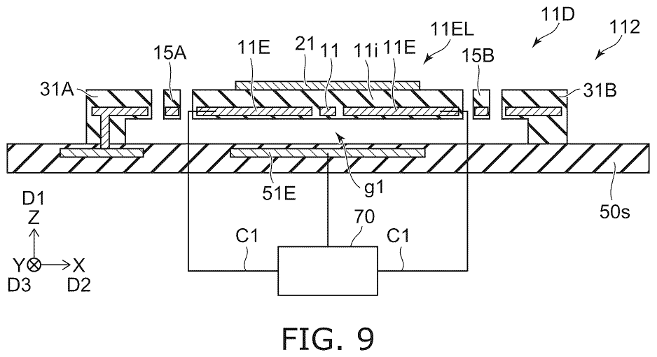

FIG. 9 is a schematic cross-sectional view illustrating a sensor according to the first embodiment.

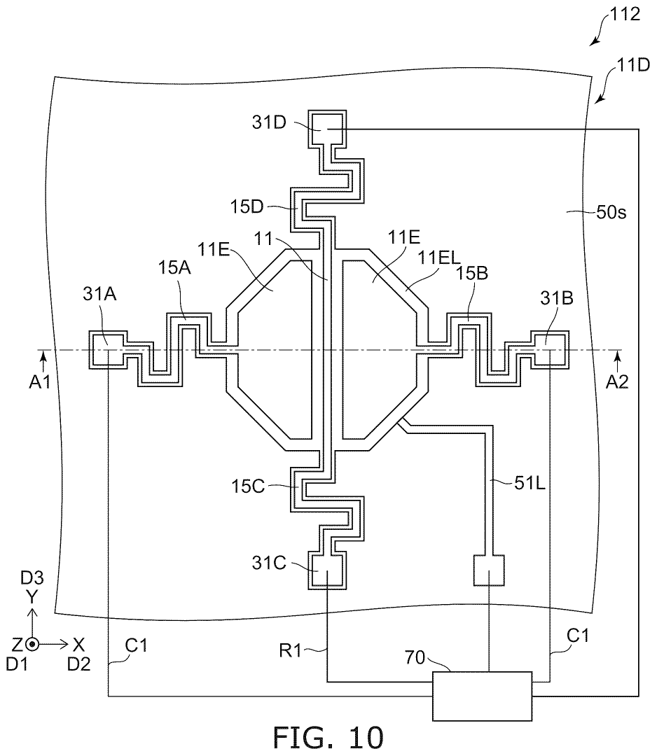

FIG. 10 is a schematic plan view illustrating the sensor according to the first embodiment.

FIG. 9 is a cross-sectional view taken along the line A1-A2 in FIG. 10.

As shown in FIG. 9, in a sensor 112 according to the embodiment, the configuration of the first element electrode 11E and the first resistance member 11 is different from that in the sensor 110. The configuration of the sensor 112 except for this may be the same as the configuration of the sensor 110.

In the sensor 112, the direction from the first element electrode 11E to the first resistance member 11 crosses the first direction D1.

As shown in FIG. 10, in this example, two first element electrodes 11E are provided. The first resistance member 11 is located between the first element electrode 11E and another first element electrode 11E.

As shown in FIG. 9, the position of the first element electrode 11E in the first direction D1 (first element electrode position) is between the position of the first base electrode 51E in the first direction D1 (first base electrode position) and the position of the first conductive member 21 in the first direction D1 (first conductive member position).

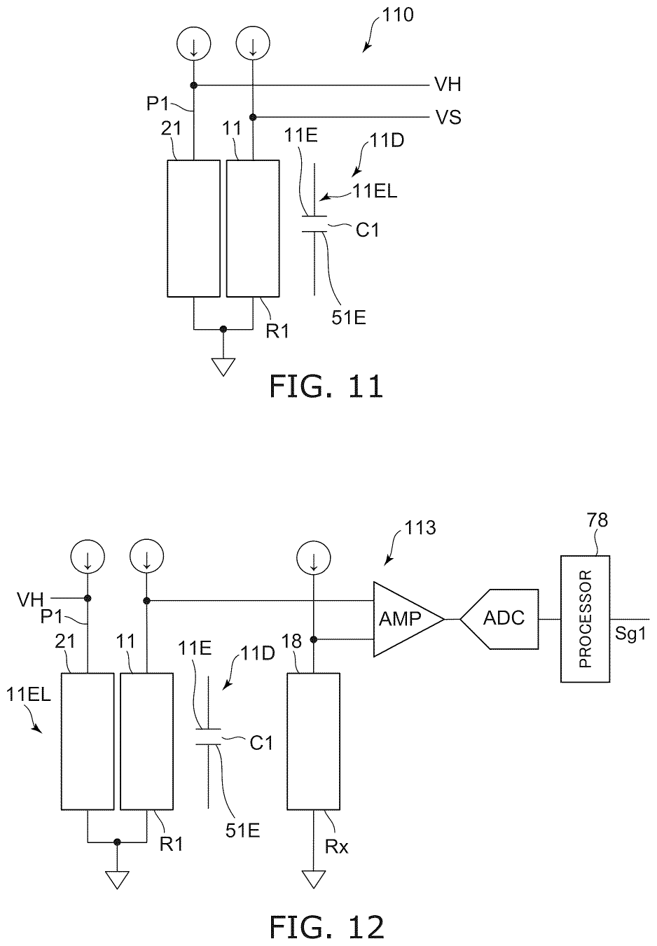

FIG. 11 is a block diagram illustrating the sensor according to the first embodiment.

As shown in FIG. 11, in the sensor 110, the first element 11EL includes the first resistance member 11, the first element electrode 11E, and the first conductive member 21. A current source is connected to the first conductive member 21, and a heater voltage VH is applied. Another current source is connected to the first resistance member 11, and the first electrical resistance R1 of the first resistance member 11 is measured. The first capacitance C1 between the first element electrode 11E and the first base electrode 51E is detected. Based on this, the output signal Sg1 being corrected is obtained based on this.

FIG. 12 is a Block Diagram Illustrating a Sensor According to the first embodiment.

As shown in FIG. 12, a sensor 113 according to the embodiment further includes a reference resistance member 18. The configuration of the sensor 113 except for this may be the same as the configuration of the sensor 110. In the sensor 113, the output signal Sg1 is obtained by correcting a value based on the first electrical resistance R1 based on the first capacitance signal SC1 (see FIG. 1) and the reference electrical resistance Rx of the reference resistance member 18. A more accurate detection result is obtained. In this example, the detection result of the difference between the potential of the first electrical resistance R1 and the potential of the reference electrical resistance Rx is AD converted. The AD converted value is input to the processor 78. In the processor 78, the detection result (value based on the first electrical resistance R1) is corrected to obtain the output signal Sg1. The AD converted value corresponds to the detection result of the detection target before correction (for example, gas concentration). As already described, the processor 78 may correct the coefficient for converting the value based on the first electrical resistance R1 into the gas concentration using the first capacitance signal SC1.

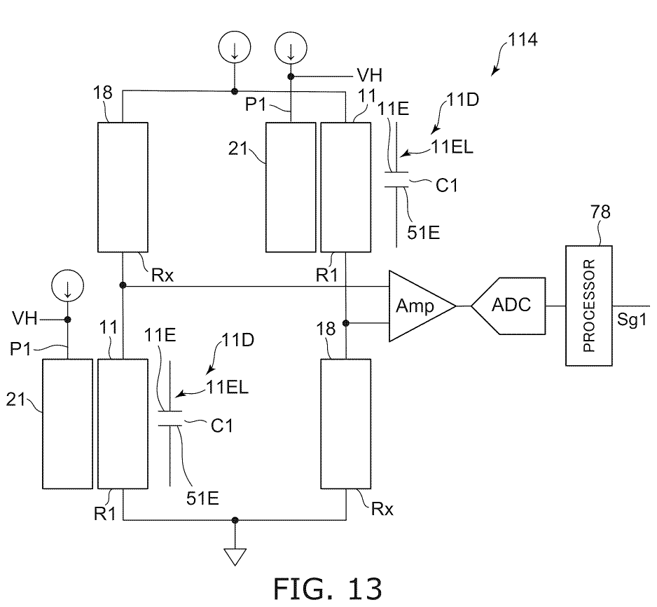

FIG. 13 is a block diagram illustrating a sensor according to the first embodiment.

As shown in FIG. 13, a sensor 114 according to the embodiment includes two reference resistance members 18 and two first detection portions 11D. The configuration of the sensor 114 except for this may be the same as the configuration of the sensor 110.

In the sensor 114, a bridge circuit is formed by the two first detection portions 11D and the two reference resistance members 18. By using a bridge circuit, more accurate detection results can be obtained more stably.

The embodiment may include the following Technical proposals:

### Technical Proposal 1

A sensor, comprising:
a base;
a first detection portion;
the first detection portion including:
   a first base electrode fixed to the base;
   a first fixed portion fixed to the base; and
   a first element supported by the first fixed portion,
the first element including a first resistance member and a first element electrode,
a first gap being provided between the first base electrode and the first element,
a first electrical resistance of the first resistance member being configured to change in response to a detection target around the first element.

### Technical Proposal 2

The sensor according to Technical proposal 1, further comprising:
a controller configured to output an output signal,
the output signal being obtained by correcting a value based on the first electrical resistance based on a first capacitance signal corresponding to a first capacitance between the first base electrode and the first element electrode.

### Technical proposal 3

The sensor according to Technical proposal 2, wherein
the first element electrode is between the first base electrode and the first resistance member.

### Technical proposal 4

The sensor according to Technical proposal 2, wherein
the first element further includes a first conductive member, and
the controller is configured to supply a first power to the first conductive member and detect a value corresponding to the first electrical resistance.

### Technical Proposal 5

The sensor according to Technical proposal 4, wherein
the first resistance member is between the first element electrode and the first conductive member in a first direction from the first base electrode to the first resistance member.

### Technical proposal 6

The sensor according to Technical proposal 4, wherein
a direction from the first element electrode to the first conductive member crosses a first direction from the first base electrode to the first resistance member.

### Technical Proposal 7

The sensor according to Technical proposal 6, wherein
a first element electrode position in the first direction of the first element electrode is between a first base position in the first direction of the first base electrode and a first resistance member position in the first direction of the first resistance member.

### Technical Proposal 8

The sensor according to Technical proposals 5 or 6, wherein
a direction from the first element electrode to the first resistance member crosses the first direction.

### Technical Proposal 9

The sensor according to Technical proposal 8, wherein
a first element electrode position in the first direction of the first element electrode is between a first base electrode position in the first direction of the first base electrode and a first conductive member position in the first direction of the first conductive member.

### Technical Proposal 10

The sensor according to any one of technical proposals 5-9, wherein
the first detection portion further includes a first connecting member,
the first connecting member is supported by the first fixed portion, and
the first connecting member supports the first element.

### Technical Proposal 11

The sensor according to Technical proposal 10, wherein
the first detection portion further includes a first wiring layer electrically connected to the first base electrode, and
at least a part of the first wiring layer does not overlap the first connecting member in the first direction.

### Technical Proposal 12

The sensor according to Technical proposal 11, wherein
the first wiring layer is provided on the base, and
a protruding portion is formed by the first wiring layer.

### Technical Proposal 13

The sensor according to any one of Technical proposals 10-12, wherein
the first detection portion further includes a first element wiring member electrically connected to the first element electrode, and
the first element wiring member passes through the first connecting member.

### Technical Proposal 14

The sensor according to any one of Technical proposals 10-13, wherein
a part of the first gap is provided between the base and the first connecting member, and
a length of the first connecting member along an extending direction of the first connecting member is longer than a width of the first connecting member along a crossing direction crossing the extending direction.

### Technical Proposal 15

The sensor according to any one of Technical proposals 10-14, wherein
the first detection portion further includes
a second fixed portion fixed to the base, and
a second connecting member supported by the second fixed portion,
the second connecting member supports the first element, and
a direction from the first connecting member to the second connecting member crosses the first direction.

### Technical Proposal 16

The sensor according to Technical proposal 15, wherein
the first detection portion further includes:
a third fixed portion fixed to the base,
a third connecting member supported by the third fixed portion,
a fourth fixed portion fixed to the base, and
a fourth connecting member supported by the fourth fixed portion,
the third connecting member supports the first element,
the fourth connecting member supports the first element, and
a direction from the third connecting member to the fourth connecting member crosses a direction from the first connecting member to the second connecting member.

### Technical Proposal 17

The sensor according to Technical proposal 16, wherein
the conductive layer electrically connected to the first resistance member passes through one of the first connecting member, the second connecting member, the third connecting member, and the fourth connecting member.

### Technical Proposal 18

The sensor according to Technical proposal 2, further comprising:
a reference resistance member,
the output signal being obtained by correcting the value based on the first electrical resistance based on the first capacitance signal and a reference electrical resistance of the reference resistance member.

### Technical Proposal 19

The sensor according to Technical proposal 2, further comprising:
two reference resistance members,
two of the first detection parts being provided, and
a bridge circuit being formed by the two first detection parts and the two reference resistance members.

### Technical Proposal 20

The sensor according to Technical proposal 2, wherein
the controller is configured to output information corresponding to a distance between the first base electrode and the first element electrode.
According to the embodiment, a sensor can be provided that allows for improved characteristics.

In the specification, “electrically connected” includes a state in which plurality of conductors are physically in contact with each other and current flows between these plurality of conductors. “Electrically connected” includes a state in which a conductor is inserted between plurality of conductors and current flows between these plurality of conductors.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as bases, detection portions, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base;
a first detection portion;
the first detection portion including:
a first base electrode fixed to the base;
a first fixed portion fixed to the base; and
a first element supported by the first fixed portion,
the first element including a first resistance member and a first element electrode,
a first gap being provided between the first base electrode and the first element,
a first electrical resistance of the first resistance member being configured to change in response to a detection target around the first element.

2. The sensor according to claim 1, further comprising:
a controller configured to output an output signal,
the output signal being obtained by correcting a value based on the first electrical resistance based on a first capacitance signal corresponding to a first capacitance between the first base electrode and the first element electrode.

3. The sensor according to claim 2, wherein
the first element electrode is between the first base electrode and the first resistance member.

4. The sensor according to claim 2, wherein
the first element further includes a first conductive member, and
the controller is configured to supply a first power to the first conductive member and detect a value corresponding to the first electrical resistance.

5. The sensor according to claim 4, wherein
the first resistance member is between the first element electrode and the first conductive member in a first direction from the first base electrode to the first resistance member.

6. The sensor according to claim 4, wherein
a direction from the first element electrode to the first conductive member crosses a first direction from the first base electrode to the first resistance member.

7. The sensor according to claim 6, wherein
a first element electrode position in the first direction of the first element electrode is between a first base position in the first direction of the first base electrode and a first resistance member position in the first direction of the first resistance member.

8. The sensor according to claim 5, wherein
a direction from the first element electrode to the first resistance member crosses the first direction.

9. The sensor according to claim 8, wherein
a first element electrode position in the first direction of the first element electrode is between a first base electrode position in the first direction of the first base electrode and a first conductive member position in the first direction of the first conductive member.

10. The sensor according to claim 5, wherein
the first detection portion further includes a first connecting member,
the first connecting member is supported by the first fixed portion, and
the first connecting member supports the first element.

11. The sensor according to claim 10, wherein
the first detection portion further includes a first wiring layer electrically connected to the first base electrode, and
at least a part of the first wiring layer does not overlap the first connecting member in the first direction.

12. The sensor according to claim 11, wherein
the first wiring layer is provided on the base, and
a protruding portion is formed by the first wiring layer.

13. The sensor according to claim 10, wherein
the first detection portion further includes a first element wiring member electrically connected to the first element electrode, and
the first element wiring member passes through the first connecting member.

14. The sensor according to claim 10, wherein
a part of the first gap is provided between the base and the first connecting member, and
a length of the first connecting member along an extending direction of the first connecting member is longer than a width of the first connecting member along a crossing direction crossing the extending direction.

15. The sensor according to claim 10, wherein
the first detection portion further includes
a second fixed portion fixed to the base, and
a second connecting member supported by the second fixed portion,
the second connecting member supports the first element, and
a direction from the first connecting member to the second connecting member crosses the first direction.

16. The sensor according to claim 15, wherein
the first detection portion further includes:
a third fixed portion fixed to the base,
a third connecting member supported by the third fixed portion,
a fourth fixed portion fixed to the base, and
a fourth connecting member supported by the fourth fixed portion,
the third connecting member supports the first element,
the fourth connecting member supports the first element, and
a direction from the third connecting member to the fourth connecting member crosses a direction from the first connecting member to the second connecting member.

17. The sensor according to claim 16, wherein
the conductive layer electrically connected to the first resistance member passes through one of the first connecting member, the second connecting member, the third connecting member, and the fourth connecting member.

18. The sensor according to claim 2, further comprising:
a reference resistance member,
the output signal being obtained by correcting the value based on the first electrical resistance based on the first capacitance signal and a reference electrical resistance of the reference resistance member.

19. The sensor according to claim 2, further comprising:
two reference resistance members,
two of the first detection parts being provided, and
a bridge circuit being formed by the two first detection parts and the two reference resistance members.

20. The sensor according to claim 2, wherein
the controller is configured to output information corresponding to a distance between the first base electrode and the first element electrode.
